(19) United States
(12) Patent Application Publication
(10) Pub. No.: US 2011/0230236 A1
(43) Pub. Date: Sep. 22, 2011

(54) Integrated System for Remote Monitoring Home Appliances by Cell Phone

(76) Inventors: Chung-Yung Tsai, Hsichih (TW); Wei-Hsiang Wang, Hsichih (TW); Chih-Chiang Kuo, Hsichih (TW)

(21) Appl. No.: 13/051,080

(22) Filed: Mar. 18, 2011

(30) Foreign Application Priority Data
Mar. 19, 2010 (TW) 099108143

(51) Int. Cl. H04B 1/38

(52) U.S. Cl. 455/557

(57) ABSTRACT

The present invention discloses an integrated system for remote monitoring home appliances by a cell phone. In the integrated system, a cell phone sends an instruction message to a computer by a wireless network. A digital control disk connected with the computer generates a control signal in accordance with the instruction message. The control signal is sent by a wireless transceiver circuit to a home appliance. Moreover, a state signal that includes information of the home appliance operation can be sent to the digital control disk. Through the computer connecting to the wireless network, the cell phone is informed of the information of the home appliance operation. Thereby, the user can control the home appliances and acquire the current operation states of the home appliances by his/her cell phone.

### BACKGROUND OF THE INVENTION

1. Field of the Invention

The present invention relates to remote control technology, and more particularly, to an integrated system for remote monitoring home appliances by a cell phone.

2. Description of the Prior Art

Taiwan Patent 518876 discloses a method for remote controlling a home gateway for controlling an electrical appliance by an indoor line. The method comprises starting the electrical appliance by using a phone in remote controlling the home gateway such that, after the home gateway has been automatically connected to the Internet, a user can control the electrical appliance by means of Internet connection, wherein the home gateway is at least one of a wide area connection port connectable to a wide area network (WAN) and a local area network (LAN) connection port connectable to an internal computer apparatus. Taiwan Patent 518876 has a drawback: home appliances can function, only if the home gateway is electrically connected to the indoor line; as a result, the technology has been implemented in the indoor line from the renovation stage, thereby restricting its application.

Taiwan Published Patent Application 200735577 discloses a method and device for remote controlling home appliances. The method comprises sending a data message from a sending end to a receiving end to perform complicated remote control on home appliances in the vicinity of the position of the receiving end by message transmission. The patent application discloses: a home telephone has to be equipped with a telephone set module; a home appliance has to be equipped with a home appliance circuit control module; the two modules are connected to a PHS network; and a user sends data message to the telephone set module via the PHS network, so as to control the operation of the home appliance. However, the above technical solution disclosed in the patent application has a drawback: although an instruction can be sent to a home appliance, the current operation states of the home appliance cannot be controlled.

Taiwan Published Patent Application 200623718 discloses a digital home network system comprising a home appliance, a telecommunication network, a telecommunication workstation for performing data exchange, a wireless access point, and a control terminal. The wireless access point comprises an antenna and a wireless receiving/transmitting system, and can read a RFID tag embedded in the home appliance. Each said RFID tag has a unique electronic code. Hence, the control terminal (a telephone or a cell phone) controls communication by means of the telecommunication network and the telecommunication workstation. The data exchange between the control terminal and the wireless access point takes place in the telecommunication workstation, so as to enable the control terminal to exercise remote control over the home appliance. However, the above technical solution disclosed in the patent application has drawbacks. For example, the above technical solution disclosed in the patent application requires that a RFID tag be embedded in a home appliance, and consumers have to buy home appliances in which RFID tags are embedded, respectively; and, any attempt to control a wide variety of home appliances would entail having a RFID tag embedded in each of the home appliances and thereby updating almost all the old versions of the home appliances before the overall system operation can start; as a result, high costs would be incurred in embedding the RFID tags in the home appliances.

According to the aforesaid prior art, there is still room for improvement in the technology of remote controlling home appliances. Accordingly, the present invention puts forth an integrated system for remote monitoring home appliances by a cell phone with a view to overcoming the existing drawbacks of the prior art by enhancing ease of installation and cutting costs.

### BRIEF SUMMARY OF THE INVENTION

A primary objective of the present invention is to provide an integrated system for remote monitoring home appliances by a cell phone, so as to integrate cell phones, computers, microcontrollers, and home appliances in terms of communication techniques, such that a user can control home appliances by a cell phone when away from home or enquire about the current operation states of home appliances.

Another objective of the present invention is to provide an integrated system for remote monitoring home appliances by a cell phone, so as to incur low costs in installation, effectuate, upon completion of the installation, the remote monitoring of various home appliances which come in different sizes and are in wide use, and introduce the system to every household ultimately.

Yet another objective of the present invention is to provide an integrated system for remote monitoring home appliances by a cell phone, so as to dispense with a complicated line and thus enable a user to perform simple do-it-yourself installation.

In order to achieve the above and other objectives, the present invention provides an integrated system for remote monitoring home appliances by a cell phone. The system comprises: a hand-held mobile device for sending an instruction message to a computer; the computer electrically connected to a central control module, the central control module having a first wireless transceiver circuit such that, after the computer has received the instruction message, the central control module connected to the computer generates a control signal according to the instruction message; and a wireless transceiver circuit sends the control signal to a home appliance; wherein the home appliance performs an operation according to the control signal, the home appliance sends a state signal to a digital control disk; wherein the computer in connection to the central control module sends the state signal to the hand-held mobile device, and then the hand-held mobile device informs a user of the current state of the home appliance.

The home appliances are consumer electronics (such as air conditioners) each equipped with a wireless receiving circuit, or are small switch-type consumer electronics (such as electrical lamps) each electrically connected to a consumer electronic control module.

### BRIEF DESCRIPTION OF THE SEVERAL VIEWS OF THE DRAWINGS

To enable persons skilled in the art to fully understand the objectives, technical disclosures, features, and attainable advantages of the present invention, the present invention is hereunder illustrated with specific embodiments in conjunction with the accompanying drawings, in which:

FIG. 1 is a schematic block diagram of a first embodiment of the present invention; and

FIG. 2 is a schematic block diagram of a second embodiment of the present invention.

### DETAILED DESCRIPTION OF THE EMBODIMENTS

The present invention relates to an integrated system for remote monitoring home appliances by a cell phone. The system is capable of remote monitoring small consumer electronics or large consumer electronics at home. The small consumer electronics are general home electrical appliances operable not by wireless remote control, such as an electrical lamp, an electric fan, a radio cassette recorder, or a dehumidifier. The large consumer electronics are general home electrical appliances operable by wireless remote control, such as an electric fan, a hi-fi, a television set, or an air conditioner capable of infrared transmission.

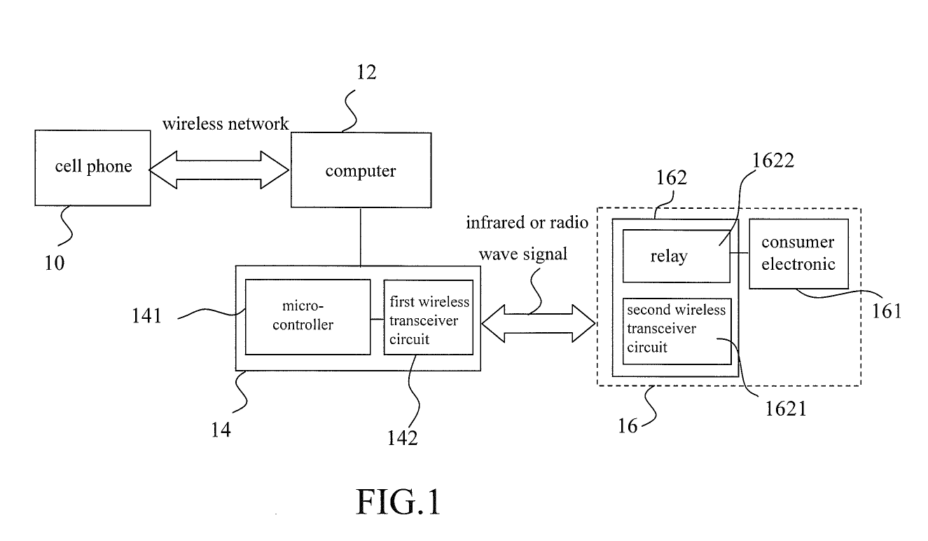

A first embodiment of the present invention illustrates the technical details as to how an integrated system for remote monitoring home appliances by a cell phone according to the present invention applies to home electrical appliances in general. Referring to FIG. 1, in this embodiment, which is exemplified by a home appliance of a manually-operated switch-type (as opposed to wireless remote control), an integrated system for remote monitoring home appliances comprises a computer 12 electrically connected to a central control module. In a specific embodiment, the central control module is a digital control disk 14, and the digital control disk 14 comprises a microcontroller 141 and a first wireless transceiver circuit 142. The digital control disk 14 is characterized by the ease of its installation on the computer 12. The digital control disk 14 is connected to the computer 12 by means of a RS232 connector or a universal serial bus (USB). The digital control disk 14 can send an infrared signal to a home appliance 16 or receive the infrared signal from the home appliance 16. The home appliance 16 comprises at least one consumer electronic 161, and a consumer electronic control module 162 connected to the consumer electronics 161. The consumer electronic control module 162 is electrically connected to the consumer electronics 161. The consumer electronic control module 162 is provided in the form of a consumer electronic plug adaptor. The consumer electronic plug adaptor 162 can be plugged into an electrical outlet, and then the plug of the consumer electronics 161 can be plugged into the consumer electronic plug adaptor 162. The consumer electronic plug adaptor 162 comprises a second wireless transceiver circuit 1621 and a relay 1622 for controlling the ON or OFF operation of the consumer electronics 161. A user gains wireless Internet access by a hand-held mobile device and then connects the hand-held mobile device and the computer 12 by wireless connection. In an embodiment of the present invention, the hand-held mobile device is a cell phone 10 that supports Java and wireless Internet access. In this embodiment, the digital control disk 14 is electrically connected to the computer 12 at home by means of a RS232 connector or a universal serial bus (USB). Hence, with a cell phone 10, a user can send an instruction message to the computer 12 by means of a wireless network, and then the digital control disk 14 generates a control signal according to the instruction message. Afterward, the control signal, which comes in the form of the infrared signal or a radio wave signal, is sent to the home appliance 16. Then, a third wireless transceiver circuit 1621 receives the control signal; and, as a result, the relay 1622 is driven to enable or disable the supply of power to the consumer electronics 161, thereby controlling the ON or OFF of the consumer electronics 161.

To obtain information about the current states of use of the consumer electronics, users at a remote end can take the steps as follows: sending a state signal to the first wireless transceiver circuit 142 of the digital control disk 14, by using the second wireless transceiver circuit 1621 and making reference to the state of use of the consumer electronics 161 by means of the consumer electronic control module 162 in the first embodiment; after the computer 12 obtained the state signal from the digital control disk 14, a message pertaining to the state of use of the consumer electronics 161 can be sent to a cell phone 10 by the computer 12 according to the state signal by means of the wireless network. In doing so, the users can know whether the consumer electronics are currently in the ON state or the OFF state.

The hand-held mobile device 10 is a cell phone that supports Java and wireless Internet access. A finalized software package loads into the Java 2 Micro edition (J 2M E) environment of the cell phone and creates a communication control interface on the cell phone in a manner that the communication control interface provides the instruction message required to turn on/off an electrical lamp. The cell phone gets connected to the computer 12 at home at any time by the J 2M E software and wireless Internet access. A monitoring interface developed and designed by Java standard edition (jdk 1.6.0) is constructed on the computer 12, and the computer 12 is electrically connected to the digital control disk 14 by means of a RS232 connector or a universal serial bus (USB). In the first embodiment, the first wireless transceiver circuit 142 either uses the infrared signal as the control signal to be transmitted and/or received, or uses a radio wave as the control signal. Hence, the user can create an instruction message through the communication control interface of the cell phone 10 and then send the instruction message to the monitoring interface of the computer 12. The monitoring interface instructs the digital control disk 14 to emit a control signal and send the control signal to the home appliance 16, thereby allowing the home appliance 16 to perform an operation according to the control signal.

As taught by this embodiment, given the socket-based connection and the Java program-based actuation of a wireless network connecting a cell phone (i.e., the client end) and a computer (i.e., the master control end), it is feasible to effectuate two-way communication between the cell phone and the computer through the network, such as the Internet. Accordingly, upon completion of related configuration, the users can observe the current status of home appliances in real time, using a computer and a cell phone.

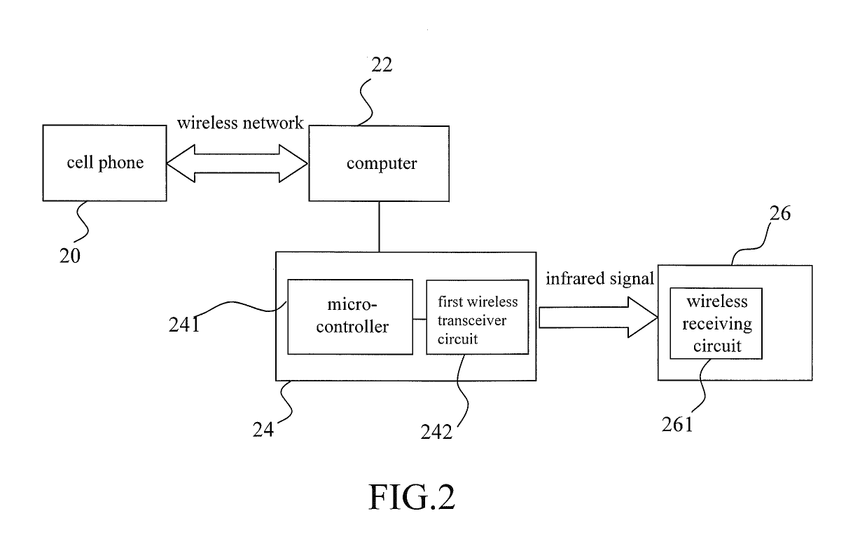

Referring to FIG. 2, a second embodiment of the present invention, which is exemplified by an air conditioner, illustrates the technical details of monitoring remotely large consumer electronics at home. In the second embodiment, a user gains wireless Internet access by a hand-held mobile device 20 and then connects the hand-held mobile device 20 and a computer 22 by wireless connection. The hand-held mobile device 20 is a cell phone that supports Java and wireless Internet access. The computer 22 is electrically connected to a digital control disk 24. The digital control disk 24 comprises a microcontroller 241 and a first wireless transceiver circuit 242. The digital control disk 24 is capable of wireless remote control of a home appliance 26. In an embodiment, the home appliance 26 is exemplified by an air conditioner 26 that has a built-in wireless receiving circuit 261, that is, an air conditioner capable of infrared transmission. The infrared signal emitted from the digital control disk 24 can be simulated as an infrared signal emitted from a remote controller of the air conditioner 26, so as to control the operation of the air conditioner 26.

Likewise, in the second embodiment of the present invention, the integrated system for remote monitoring home appliances is applicable to the control of home electrical appliances capable of wireless remote control. In the aforesaid way, the digital control disk can simulate infrared signals emitted from remote controllers of different brands, respectively. Furthermore, in the situation where the air conditioner has a wireless transceiver circuit and thereby is capable of sending out a state signal, the present invention is also applicable, such that the digital control disk is used to receive the state signal from the air conditioner. In doing so, with a cell phone, the user can obtain the usage state of the air conditioner and the information as to whether the air conditioner is functioning well, in real time.

Also, the technology of gaining wireless Internet access by a cell phone with a view to connecting the cell phone to a computer by wireless connection as disclosed in the second embodiment is illustrated in detail in the above technical disclosure of the first embodiment and thus is not described hereunder for the sake of brevity.

As revealed above, the values of the present invention lie in its low costs, prevalence, and the quick plug-and-play (PnP) function. Hence, as described above, given three types of communication media, namely the combination of the cell phone and the computer, the combination of the computer and the digital control disk, and the combination of the digital control disk and the consumer electronic control module, it is feasible to take control of the operation of one to sixteen electrical appliances at home simultaneously. In addition, the present invention circumvents the barrier between hardware and software, and boosts transmission speed greatly. Considering the popularity and prevalence of Java cell phones and RS232 transmission on the market, the present invention can better conform to various home appliance environments, so as to achieve the goal of the plug-and-play (PnP) function. Moreover, the present invention sets a relatively low requirement of the control objects, and thus the present invention widens the scope of control, and in consequence the present invention is widely applicable to home appliances in general.

Commercially available control systems similar to the system of the present invention are not only expensive and thus unpopular with families in general, but are also not in wide use. The situation where a user uses a specific home appliance in order to access a control function corresponding thereto amounts to confusing cause and effect. The advantages of the present invention are, namely dispensing with a big budget, changing no home appliances, and providing the plug-and-play (PnP) function. As disclosed in the present invention, with just a cell phone, a user can keep large home appliances or simple home appliances under control, to achieve of the goal of low prices and prevalence. Hence, before returning home on a hot day, the user can turn on air conditioners at home in advance, such that the user is greeted with the coolness at the doorstep. Also, with just a cell phone, the user can control home appliances at will. Last but not least, home safety is nowadays of vital importance to a family. Home accidents, such as a fire caused by a short circuit, electric shock, injury caused to children by home appliances, are quite common. The aforesaid tragedies can be avoided for certain, if users have a good grip of the state of use of home appliances in real time and are able to disconnect the home appliances from a power supply directly by the cell phone when away from home.

The foregoing embodiments are provided to illustrate and disclose the technical notions and features of the present invention so as to enable persons skilled in the art to understand the disclosure of the present invention and implement the present invention accordingly, and are not intended to be restrictive of the scope of the present invention. Hence, all equivalent variations or modifications made in the foregoing embodiments without departing from the spirit embodied in the disclosure of the present invention should fall within the scope of the present invention as set forth in the appended claims.

What is claimed is:

1. An integrated system for remote monitoring home appliances by a cell phone, comprising:
a hand-held mobile device, configured for sending an instruction message;
a computer, connected to the hand-held mobile device by a wireless network, and configured to receive the instruction message;
a central control module, electrically connected to the computer, the central control module comprising a first wireless transceiver circuit, wherein the central control module is configured to receive the instruction message from the computer and generate a control signal, such that the first wireless transceiver circuit sends out the control signal; and
at least one home appliance, configured for receiving the control signal, performing an operation according to the control signal, and sending a state signal to the central control module, the state signal pertaining to a current state of the home appliance, thereby allowing the computer to inform the hand-held mobile device of the current state of the home appliance.

2. The integrated system of claim 1, wherein the computer and the central control module are electrically connected by a RS232 connector or a universal serial bus (USB).

3. The integrated system of claim 1, wherein the central control module comprises a microcontroller for generating the control signal according to the instruction message.

4. The integrated system of claim 1, wherein the home appliance has a built-in wireless receiving circuit for receiving the control signal.

5. The integrated system of claim 1, wherein the home appliance comprises at least one consumer electronic and a consumer electronic control module, the consumer electronic control module further comprising a second wireless transceiver circuit and a relay and being disposed between the consumer electronic and a power supply, the second wireless transceiver circuit is configured for receiving the control signal, the relay is configured for controlling a start or a shutdown of the consumer electronic, and the consumer electronic is configured for sending out the state signal via the second wireless transceiver circuit.

6. The integrated system of claim 5, wherein the consumer electronic comprises a simple switch-type home appliance.

7. The integrated system of claim 1, wherein the hand-held mobile device supports Java and wireless Internet access; the hand-held mobile device comprises a communication control interface for providing options of the instruction message and sending the instruction message to the computer by the wireless network.

8. The integrated system of claim 1, wherein the computer comprises a monitoring interface for receiving the instruction message from the hand-held mobile device.

9. The integrated system of claim 1, wherein the control signal is infrared or radio wave.

10. The integrated system of claim 1, wherein the computer and the hand-held mobile device are connected by an end-to-end socket connection.

11. A method for remote monitoring home appliances by a cell phone, applied to an integrated system having a hand-held mobile device, a computer, a central control module, and at least one home appliance, the method comprising:
sending an instruction message from the hand-held mobile device to the computer;
transmitting the instruction message from the computer to the central control module;
generating a control signal by the central control module in order to send out the control signal;
receiving the control signal by the at least one home appliance; and
performing an operation according to the control signal by the at least one home appliance, and sending a state signal to the central control module, the state signal pertaining to a current state of the home appliance, thereby allowing the computer to inform the hand-held mobile device of the current state of the home appliance.

12. The method of claim 11, wherein the control signal is infrared or radio wave.
